(19) United States
(12) Patent Application Publication
(10) Pub. No.: US 2007/0126256 A1
(43) Pub. Date: Jun. 7, 2007

(54) Automobile sun visor and attachment for use with an automobile sun visor

(76) Inventor: Khamkong Yattavong, Brampton (CA)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/293,013

(22) Filed: Dec. 2, 2005

(51) Int. Cl. B60J 3/02

(52) U.S. Cl. 296/97.6

(57) ABSTRACT

Disclosed is an attachment for use with an automobile sun visor of the type including a visor body mounted in a vehicle interior and adapted to be positioned by a driver in at least a shielding position whereat it blocks the sun disc from the driver's view when the sun sits relatively low in the sky and the vehicle is orientated towards the sun. The attachment comprises an attachment body defining a first void and adapted to be mountable to said visor body such that said attachment body is positionable in at least a shielding position whereat it blocks the driver's view of the upper portion of the windshield. The first void, when said attachment body is disposed in its shielding position, is disposed generally frontwardly of said driver, commences adjacent the lower edge of said visor body and extends upwardly and narrows in width as it so extends.

### FIELD OF THE INVENTION

The present invention relates to the field of automobile sun visors.

### BACKGROUND OF THE INVENTION

Automobile sun visors are customarily pivotably joined at the edge of the headliner of the interior of a vehicle, adjacent the windshield. Typically, the sun visor is pivotable downward across the upper portion of the windshield. This provides a convenient mechanism to obscure the sun disk from the view of the driver when the sun sits low in the sky and ahead of the driver. However, if an automobile approaches a traffic signal in such a manner that the operator must look at the traffic signal and in the general direction of the sun at the same time, the sun visor cannot be used, and in this case, the glare of sunlight can render the driver unable to distinguish the color of the traffic signal. A similar problem can occur when an automobile is stopped at a traffic light, whereupon the operator can be unable to detect a change in the signal colors. In either event, failure of the operator to correctly discern the actual colours of the traffic signal can create a dangerous condition. Similar concerns apply in night driving, when the headlight glare from oncoming vehicles may prejudice the ability of the driver to discern traffic signals or brake lights.

### SUMMARY OF THE INVENTION

An improved automobile sun visor forms one aspect of the invention. The sun visor is of the type including a visor body mounted in the interior of a vehicle and adapted to be positioned by a driver in at least a shielding position whereat it blocks the sun disc from the view of the driver when the sun sits relatively low in the sky and the vehicle is orientated towards the sun. The improvement comprises a first void defined in said visor body, said void, when said visor body is disposed in the shielding position, being disposed generally frontwardly of said driver, commencing adjacent the lower edge of said visor body and extending upwardly and narrowing in width as it extends.

An attachment forms another aspect of the invention. The attachment is for use with an automobile sun visor of the type including a visor body mounted in the interior of a vehicle and adapted to be positioned by a driver in at least a shielding position whereat it blocks the sun disc from the view of the driver when the sun sits relatively low in the sky and the vehicle is orientated towards the sun. The attachment comprises: an attachment body defining a first void; and means for mounting said attachment body to said visor body such that said attachment body is positionable in at least a shielding position whereat it blocks the sun disc from the view of the driver when the sun sits relatively low in the sky and the vehicle is orientated towards the sun. The first void, when said attachment body is disposed in the shielding position, is disposed generally frontwardly of said driver, commences adjacent the lower edge of said visor body and extends upwardly and narrows in width as it so extends.

A further attachment forms yet another aspect of the invention. This attachment is use with an automobile sun visor of the type including a visor body mounted in the interior of a vehicle and adapted to be positioned by a driver in at least a shielding position whereat it blocks the sun disc from the view of the driver when the sun sits relatively low in the sky and the vehicle is orientated towards the sun. The attachment comprises an attachment body defining a first void and adapted to be mountable to said visor body such that said attachment body is positionable in at least a shielding position whereat it blocks the view of the driver of the upper portion of the windshield. The first void, when said attachment body is disposed in the shielding position thereof, is disposed generally frontwardly of said driver, commences adjacent the lower edge of said visor body and extends upwardly and narrowing in width as it so extends.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE DRAWINGS

FIG. 1 is a perspective a view of a prior art sun visor in a storage position thereof in a vehicle;

FIG. 2 is a view similar to FIG. 1, with the sun visor in a shielding position thereof;

FIG. 3 is a view of a sun visor attachment, according to a preferred embodiment of the invention, in use with the structure of FIG. 2, with the attachment shown in a storage position;

FIG. 4 is a view similar to FIG. 3, with the attachment shown in a shielding position;

FIG. 5 is a partial view of the structure of FIG. 4, taken from the vantage point of a driver of the vehicle;

FIG. 6 is a top plan view of a preform of the sun visor attachment of FIG. 3;

FIG. 7 is a perspective view of the sun visor attachment of FIG. 3, shown in isolation;

FIG. 8 is a view similar to FIG. 2, of an improved sun visor constructed according to a second preferred embodiment of the present invention.

FIG. 9A is a schematic view of a portion of the structure of FIG. 6, showing a right eye view;

FIG. 9B is a view similar to FIG. 9A, showing a left eye view; and

FIG. 9C is a view similar to FIG. 9A, showing a right and left eye view.

### DETAILED DESCRIPTION

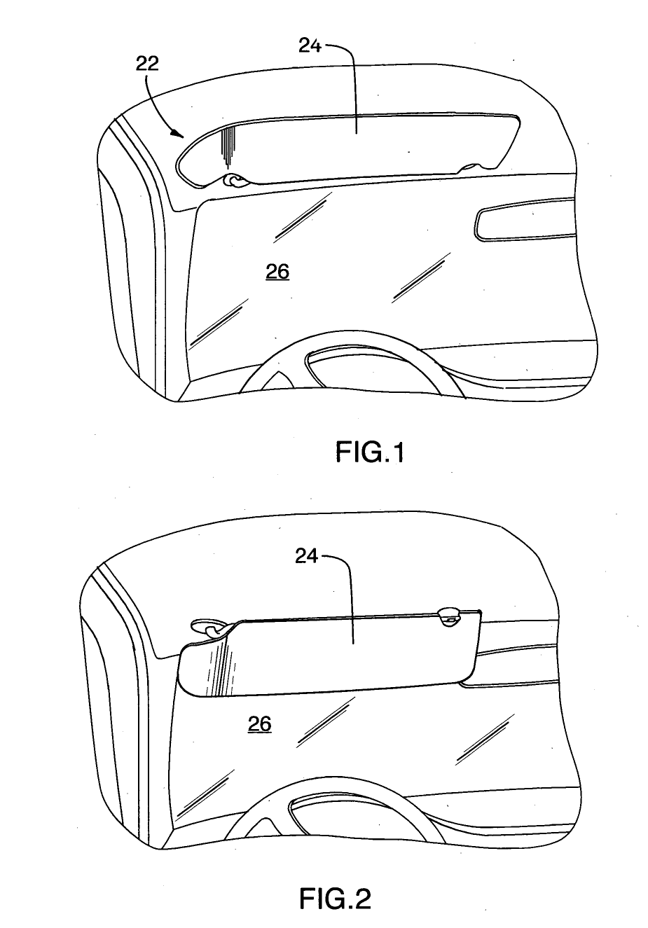

With general reference to FIG. 7, a preferred embodiment of the present invention, a sun visor attachment, is illustrated, and is designated by the general reference numeral 20. The attachment 20 is for use with a prior art automobile sun visor 22 of the type shown in FIGS. 1, 2 which includes a visor body 24 mounted in the interior of a vehicle and positionable in at least a shielding position, as shown in FIG. 2, whereat the visor body 24 blocks the view of the driver of the upper portion of the windshield 26, and a storage position as shown in FIG. 1, whereat the visor body 24 is displaced to provide to the driver an unobstructed view of the windshield 26.

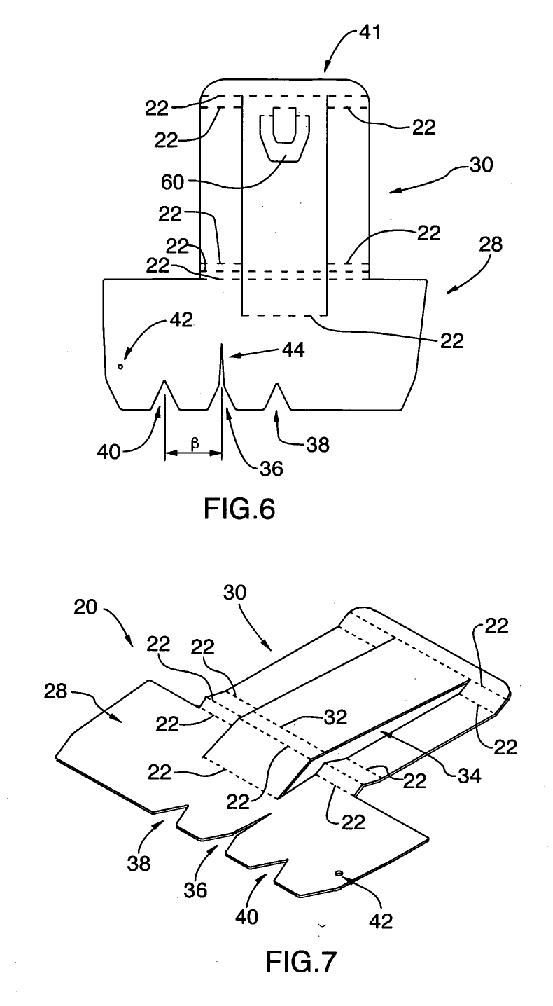

The attachment 20 comprises an attachment body 28 and mounting means 30. In the preferred embodiment illustrated, the attachment body 28 and mounting means 30 are formed out of cardboard, in a stamping operation. FIG. 6 is a top plan view of a preform, which can be folded along fold lines 22 to arrive at the structure of FIG. 7. The manner in which the structure of FIG. 6 can be folded to arrive at the structure of FIG. 7 is evident to persons of ordinary skill in the art and as such is not described in detail herein.

The attachment body 28 is a generally planar body adapted for mounting to the visor body 24 such that attachment body 28 can be disposed in at least a shielding position, as shown in FIG. 4, whereat it blocks the sun disc from the view of the driver when the sun sits relatively low in the sky and the vehicle is orientated towards the sun. In the illustrations, this adaptation of the attachment body 28 is provided by a mounting means for mounting the attachment body 28 to the visor body 24, which mounting means 30 takes the form of a cardboard structure which, in combination with attachment body 28, defines a passage 34 through which the visor body 24 can be extended, as shown in FIG. 4. The attachment body 28 defines a first void 36, a second void 38, a third void 40 and an aperture 42.

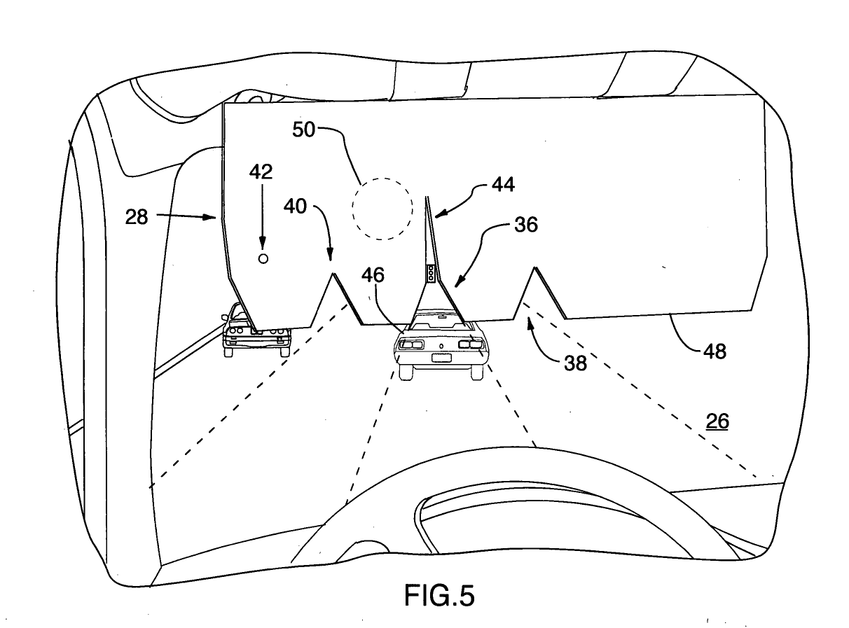

The first void 36 takes the form of a notch which, when the attachment body is disposed in the shielding position as shown in FIGS. 4, 5, is formed on a lower edge 48 of the attachment body 28, is disposed generally frontwardly of said driver, commences adjacent the lower edge 48 of said attachment body 28 extends upwardly and narrows in width as it so extends. As indicated in FIG. 5, the notch 36 is shaped so as to provide to said driver a substantially unobstructed view of a straight road lane extending ahead of the vehicle to the horizon when the attachment body 28 is disposed in the shielding position. The limits of the straight road lane extending ahead of the vehicle in FIG. 5 are delimited in dotted outline 46. The notch 36 includes an upper portion 44 which extends a substantial distance across the width of the attachment body 28.

The second void 38 also takes the form of a notch which, when the attachment body 28 is disposed in the shielding position as shown, is formed on the lower edge 48 of the attachment body, on one side of the first void 36, and extends upwardly and narrows in width as it so extends. The second void 38 is spaced from the first void 36 such that the driver can peer, one eye through each of the first void 36 and second void 38, at distant objects ahead of the vehicle when said attachment body 28 is disposed in the shielding position.

The third void 40 also takes the form of a notch which, when the attachment body 28 is disposed in the shielding position as shown, is formed on a lower edge 48 of the attachment body 28. The third void 40 is disposed on the side of the first void 36 opposite the second void 38 and commences adjacent the lower edge 48 of said attachment body, extends upwardly and narrows in width as it so extends. The third void 40 is spaced from the first void 36 such that the driver can peer, one eye through each void 36, 40, at distant objects ahead of the vehicle when said attachment body 28 is disposed in the shielding position.

The aperture 42 is shaped and positioned to permit a driver stopped at an intersection to view therethrough a traffic light mounted centrally of said intersection (not shown), when said attachment body 28 is disposed in the shielding position.

In use, the attachment 20 is manipulated such that a conventional sun visor 24 is extended through the passage 34.

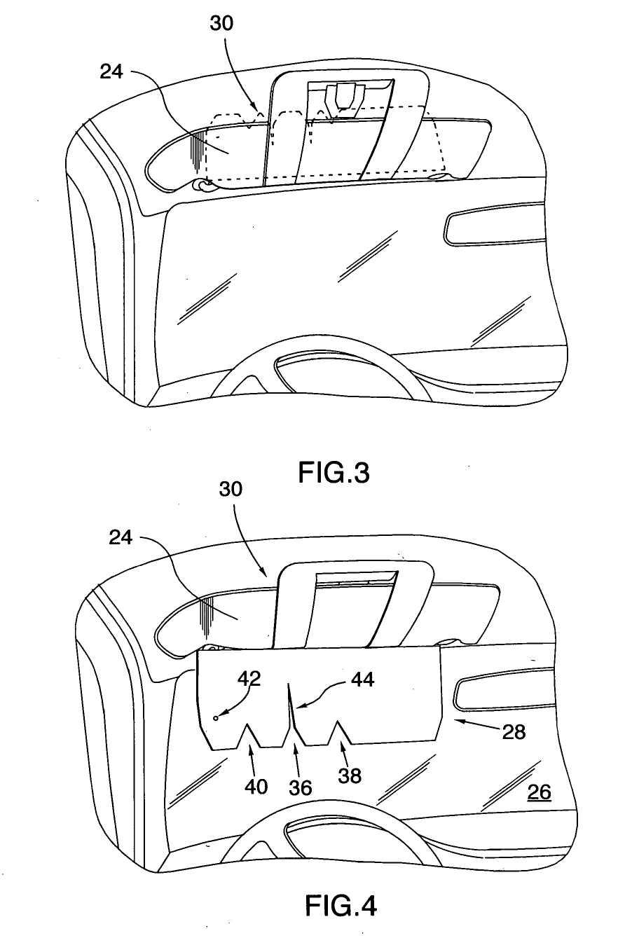

In situations where the sun is high in the sky, beside or behind the driver, the attachment body 28 can be flipped up out of the way to a storage position, as shown in FIG. 3, thereby to provide to the driver an un-obscured view through the windshield 26. Tab 60 can be manipulated so as to bear against the edge of the sun visor 24, such that the attachment 20 is completely out of the way of the driver.

When the sun sits relatively low in the sky and the vehicle is orientated towards the sun, the attachment body 28 can be flipped out from the storage position and disposed in the shielding position, to obscure the upper portion of the windshield 26 from the view of the driver, as shown in FIG. 4. In this use, tab 60 is manipulated so as to pass behind the visor 24, such that the attachment 20 slides down, so as to be appropriately positioned for use.

With the attachment body 28 in this shielding position, the driver maintains a completely unobstructed view of the area immediately in front of the vehicle. As well, if the driver is approaching an intersection, he or she can keep a centrally located traffic signal in sight by shifting head position, such that the traffic signal is disposed in the primary notch 36. The narrowness of the upper portion 44 of the notch 36 renders it possible to view the traffic signal with the sun disc fully concealed, as indicated in FIG. 5, where the sun disc is shown in dotted outline 50. At the intersection, where the traffic signal may be located towards the left side of the driver, the driver may locate the traffic signal through the aperture 42. The elongated nature of notch 36 provides a long-distance vantage for the driver, even with the attachment 20 in the shielding position, which enables the driver to continue to operate the vehicle at normal cruising speeds with confidence.

The spacing of the notches 36, 38, 40 also provides to the driver an opportunity to view distant objects, by peering one eye through each of the first 36 and second 38, or first 36 and third 40, voids, while keeping the sun disc obscured. The first 36 and third 40 voids, and first 36 and second 38 voids, are spaced from one another a distance β which is similar to the interocular distance of human eyes, to facilitate such viewing. An advantage flowing from this arrangement is that eye strain is reduced, and the driver is not required to rely on one eye or the other to view distant objects, which could be problematic for those with weak eyesight in one or both eyes.

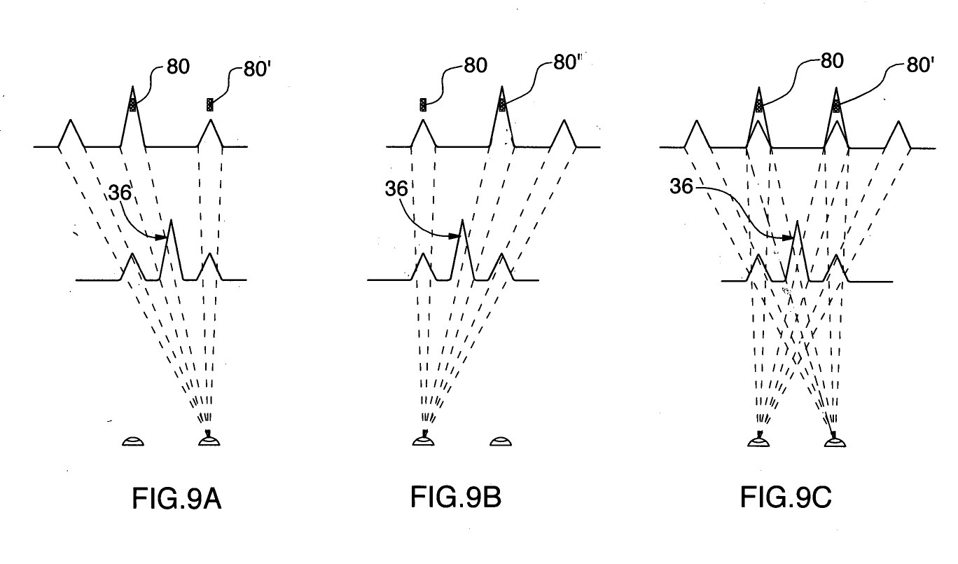

Another use is illustrated schematically in FIGS. 9A, 9B, 9C. In this use, the driver views through the notches with each eye, to produce two different images, which are resolved by the brain of the driver. The notch arrangement of the structure of FIG. 4 is shown representatively in each of FIGS. 9A, 9B, 9C, along with two objects of interest, in this example, traffic lights 80, 80′. FIG. 9A shows a schematic right eye view; wherein light 80 is visible by the right eye through notch 36. FIG. 9B shows a schematic left eye view, wherein light 80′ is visible by the left eye through notch 36. FIG. 9C shows a schematic left and right eye view, wherein light 80 is visible by the right eye through notch 36 and light 80′ is visible by the left eye through notch 36.

As indicated in FIG. 9C, the arrangement of notches in the preferred embodiment illustrated is such that the left and right eye images of the left and right flanking notches, respectively, can be superimposed upon the right and left eye images of the central notches 36. Without intending to be bound by theory, it is believed that this arrangement may provide enhanced visual clarity in the area of superimposition, with consequent benefits to driver safety.

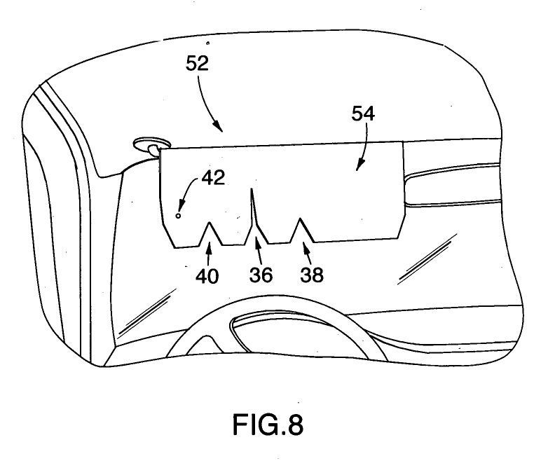

A second preferred embodiment of the present invention is shown in FIG. 8. This figure shows an improved automobile sun visor 52, of the type including a visor body mounted in the interior of a vehicle and adapted to be positioned by a driver in at least a shielding position whereat it blocks the sun disc from the view of the driver when the sun sits relatively low in the sky and the vehicle is orientated towards the sun. The visor body 54 in this arrangement is substantially identical in structure, and operates in substantially identical manner, to the attachment body 28 of the first preferred embodiment, and the parts thereof are numbered similarly. Accordingly, the visor body of this preferred embodiment is not further described.

Whereas but two embodiments of the present invention have been herein shown and described, it will be understood that various changes in size and shape of parts may be made. Accordingly, it should be understood that the scope of the present invention is to be limited only by the claims appended hereto, purposively construed.

1. An improved automobile sun visor of the type including a visor body mounted in the interior of a vehicle and adapted to be positioned by a driver in at least a shielding position whereat it blocks the sun disc from the view of the driver when the sun sits relatively low in the sky and the vehicle is orientated towards the sun, the improvement comprising:
a first void defined in said visor body, said first void, when said visor body is disposed in the shielding position, being disposed generally frontwardly of said driver, commencing adjacent the lower edge of said visor body and extending upwardly and narrowing in width as it so extends.

2. An improved visor according to claim 1, wherein the first void is a notch formed in said lower edge of said visor body.

3. An improved visor according to claim 2, wherein the notch is shaped so as to provide to said driver a substantially unobstructed view of a straight road extending ahead of the vehicle to the horizon when the visor body is at its shielding position.

4. An improved visor according to claim 1, further comprising a second void defined in said visor body, said second void, when said visor body is disposed in the shielding position, being disposed on one side of the first void, commencing adjacent the lower edge of said visor body and extending upwardly and narrowing in width as it so extends.

5. An improved visor according to claim 4, wherein the first and second voids are spaced apart from one another such that said driver can peer, one eye through each void, at distant objects, when the visor body is at its shielding position.

6. An improved visor according to claim 4, wherein the second void is a notch formed in said lower edge of said visor body.

7. An improved visor according to claim 4, further comprising a third void defined in said body, said third void, when said visor body is disposed in the shielding position, being disposed on the side of the first void opposite the second void, commencing adjacent the lower edge of said visor body and extending upwardly and narrowing in width as it so extends.

8. An improved visor according to claim 7, wherein the first and third voids are spaced apart from one another such that said driver can peer, one eye through each void, at distant objects, when the visor body is at the shielding position.

9. An improved visor according to claim 7, wherein the third void is a notch formed in said lower edge of said visor body.

10. An improved visor according to claim 1, further comprising an aperture defined therethrough which is shaped and positioned to permit a driver stopped at an intersection to view therethrough a traffic light mounted centrally of said intersection, when the visor body is at its shielding position.

11. An attachment for use with an automobile sun visor of the type including a an attachment body defining a first void; and visor body mounted in the interior of a vehicle and adapted to be positioned by a driver in at least a shielding position whereat it blocks the sun disc from the view of the driver when the sun sits relatively low in the sky and the vehicle is orientated towards the sun, the attachment comprising:
means for mounting said attachment body to said visor body such that said attachment body is positionable in at least a shielding position whereat it blocks the view of the driver of the upper portion of the windshield,
said first void, when said attachment body is disposed in the shielding position thereof, being disposed generally frontwardly of said driver, commencing adjacent the lower edge of said visor body and extending upwardly and narrowing in width as it so extends.

12. An attachment according to claim 11, wherein the first void is a notch formed in said lower edge of said attachment body when the attachment body is disposed in the shielding position.

13. An attachment according to claim 12, wherein the notch is shaped so as to provide to said driver a substantially unobstructed view of a straight road lane extending ahead of the vehicle to the horizon when the attachment body is disposed in the shielding position.

14. An attachment according to of claim 11, wherein the attachment body further defines a second void, said second void, when said attachment body is disposed in the shielding position, being disposed on one side of the first void, commencing adjacent the lower edge of said attachment body and extending upwardly and narrowing in width as it so extends.

15. An attachment according to claim 14, wherein the first and second voids are spaced apart from one another such that said driver can peer, one eye through each void, at distant objects, when said attachment body is disposed in the shielding position.

16. An attachment according to claim 14, wherein the second void is a notch formed in said lower edge of said attachment body when the attachment body is disposed in the shielding position.

17. An attachment according to claim 14, wherein the attachment body further defines a third void, said third void, when said attachment body is disposed in the shielding position, being disposed on the side of the first void opposite the second void and commencing adjacent the lower edge of said attachment body and extending upwardly and narrowing in width as it so extends.

18. An attachment according to claim 17, wherein the first and third voids are spaced apart from one another such that said driver can peer, one eye through each void, at distant objects, when said attachment body is disposed in the shielding position.

19. An attachment according to claim 17, wherein the third void is a notch formed in said lower edge of said attachment body when said attachment body is disposed in the shielding position.

20. An attachment according to claim 11, wherein the attachment body further defines an aperture which is shaped and positioned to permit a driver stopped at an intersection to view therethrough a traffic light mounted centrally of said intersection, when said attachment body is disposed in the shielding position and the attachment body is mounted thereto.

21. An attachment for use with an automobile sun visor of the type including a visor body mounted in the interior of a vehicle and adapted to be positioned by a driver in at least a shielding position whereat it blocks the sun disc from the view of the driver when the sun sits relatively low in the sky and the vehicle is orientated towards the sun, the attachment comprising:
an attachment body defining a first void and adapted to be mountable to said visor body such that said attachment body is positionable in at least a shielding position whereat it blocks the view of the driver of the upper portion of the windshield,
said first void, when said attachment body is disposed in the shielding position thereof, being disposed generally frontwardly of said driver, commencing adjacent the lower edge of said visor body and extending upwardly and narrowing in width as it so extends.
